(19) United States
(12) Patent Application Publication
(10) Pub. No.: US 2026/0254777 A1
(43) Pub. Date: Aug. 27, 2026

(54) PACKET MIRRORING IN VIRTUAL NETWORKS USING DISAGGREGATED NETWORK FUNCTIONS

(71) Applicant: Microsoft Technology Licensing, LLC, Redmond, WA (US)

(72) Inventors: Chaitanya Kiran RAJE, Sammamish, WA (US); Rishabh TEWARI, Sammamish, WA (US); Michal Czeslaw ZYGMUNT, Kirkland, WA (US); Avijit GUPTA, Sammamish, WA (US); Pranjal SHRIVASTAVA, Bothell, WA (US)

(21) Appl. No.: 19/063,256

(22) Filed: Feb. 25, 2025

(51) Int. Cl. H04L 49/20; H04L 45/24; H04L 69/22

(52) U.S. Cl. CPC H04L 49/208; H04L 45/24; H04L 69/22

(57) ABSTRACT

Packet mirroring in virtual networks (VNets) uses disaggregated network functions, in which packet mirroring functionality is implemented on remotely-located switches positioned as intermediate hops between origin (source) virtual machines (VMs) and destination VMs. An origin VM transmits an original packet to the switch, which acts as a mirroring node and where the mirroring is offloaded to fast hardware. Application-specific integrated circuits (ASICs) may be used for speed and reduced complexity. This approach of leveraging hardware-based mirroring at an intermediary position eliminates the need for mirroring operations on the origin VM or host, preserving bandwidth and computational resources for the primary workload. The original packet, which carries the data intended for the destination VM, is encapsulated twice at the origin-once for transport across a VNet, and again with metadata for the mirroring included within the encapsulating packet. Some examples use Geneve packets, with the mirror metadata within the Geneve header.

### BACKGROUND

Packet mirroring creates copies of data traffic passing through networks, such as packets passing from one virtual machine (VM) instance to another, across a virtual network (VNet). By duplicating packets, and sending the duplicates to a monitoring location, network administrators, security analysts, and other stakeholders are able to gain visibility into network behavior, troubleshoot issues, enhance network performance, and identify security threats.

Traditionally, packet mirroring in VNets uses either a VM mirroring agent somewhere within the VNet, or host-based packet mirroring, in which the host itself duplicates each outgoing packet, one being sent to the primary destination, and the other to the mirroring location that receives the mirrored (copied, duplicated) packets for analysis. Both approaches introduce inefficiencies. The VM mirroring agent is able to handle only half of its actual capacity (because each packet it handles must be duplicated) limiting bandwidth, and host-based packet mirroring similarly reduces capacity of the host hardware (e.g., the network driver).

### SUMMARY

The disclosed examples are described in detail below with reference to the accompanying drawing figures listed below. The following summary is provided to illustrate some examples disclosed herein.

Solutions disclosed herein provide for packet mirroring in virtual networks using disaggregated network functions. Examples generate, at an origin host hosting an origin virtual machine (VM), a first packet in a first format comprising a first header and a first payload, wherein the first header identifies the origin VM as a source and a destination VM at a destination host as a destination, and wherein the first payload comprises data being sent from the origin VM to the destination VM; encapsulate, at the origin host, the first packet in a second payload of a second packet in a second format comprising a second header, wherein the second format comprises a virtual network (VNet) packet format, and wherein the second header identifies the origin host as a source and the destination host as a destination; encapsulate, at the origin host, the second packet in a third payload of a third packet in a third format comprising a third header, wherein the third format comprises a network encapsulation protocol packet format, and wherein the third header identifies a mirroring node within a VNet as a destination; transmit, across the VNet, the third packet from the origin host toward the destination host hosting the destination VM; extract, at the mirroring node, the second packet from the third packet; forward, by the mirroring node, the second packet to the destination VM; and mirror, by the mirroring node, at least the first packet.

### BRIEF DESCRIPTION OF THE DRAWINGS

The disclosed examples are described in detail below with reference to the accompanying drawing figures listed below:

FIG. 1 illustrates an example architecture that advantageously provides for packet mirroring in virtual networks using disaggregated network functions;

FIG. 2 illustrates an exemplary data packet, as may be used in examples of the architecture of FIG. 1;

FIG. 3 illustrates an exemplary virtual network (VNet) packet, as may be used in examples of the architecture of FIG. 1, encapsulating the data packet of FIG. 2;

FIG. 4 illustrates an exemplary network encapsulation protocol packet, as may be used in examples of the architecture of FIG. 1, encapsulating the data packet of FIG. 3;

FIG. 5 illustrates an exemplary VNet mirrored packet, as may be used in examples of the architecture of FIG. 1, encapsulating the data packet of FIG. 2;

FIG. 6 illustrates another exemplary VNet packet, as may be used in examples of the architecture of FIG. 1, encapsulating the data packet of FIG. 5;

FIGS. 7 and 78 show flowcharts illustrating exemplary operations that may be performed when using example architectures, such as the architecture of FIG. 1; and

FIG. 9 shows a block diagram of an example computing device suitable for implementing some of the various examples disclosed herein.

Corresponding reference characters indicate corresponding parts throughout the drawings.

### DETAILED DESCRIPTION

Packet mirroring in virtual networks (VNets) uses disaggregated network functions, in which packet mirroring functionality is implemented on remotely-located switches positioned as intermediate hops between origin (source) virtual machines (VMs) and destination VMs. An origin VM transmits an original packet to the switch, which acts as a mirroring node and where the mirroring is offloaded to fast hardware. Application specific integrated circuits (ASICs) may be used for speed and reduced complexity. This approach of leveraging hardware-based mirroring at an intermediary position eliminates the need for mirroring operations on the origin VM or host, preserving bandwidth and computational resources for the primary workload. The original packet, which carries the data intended for the destination VM, is encapsulated twice at the origin—once for transport across a VNet, and again with metadata for the mirroring included within the encapsulating packet. Some examples use Geneve packets, with the mirror metadata within the Geneve header, although different packet formats may be used. This permits stateless mirroring, avoiding the need to reprogram the mirroring node when there is a change to the mirrored packet destination.

Aspects of the disclosure solve multiple problems that are necessarily rooted in computer technology, and render use of computing platforms more efficient in common use cases (i.e., packet mirroring), by providing the practical result of improving the efficiency of mirroring operations. For example, bandwidth demands on the origin host are reduces, and the mirroring node is able to efficiently off-load mirroring to a fast, efficient, stateless hardware operation. This significantly improves the use of computers for network operations, such as transporting packets across a virtual network. These advantageous results are accomplished, at least in part, by two-layered encapsulation at the origin host.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

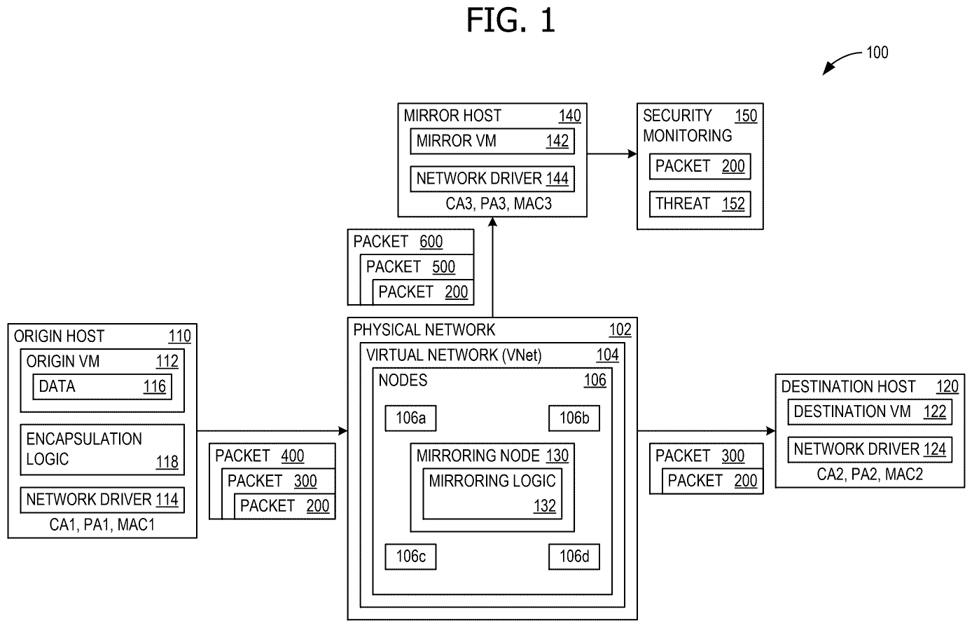

FIG. 1 illustrates an example architecture 100 that advantageously provides for packet mirroring in a VNet 104 that overlays a physical network 102 comprising physical servers, such as server blades in sets of racks. The server blades host various VMs, which operate on the physical servers. The server blades within each rack are connected to the top-of-rack (ToR) routers. These routers, in turn, are linked to a hierarchical mesh of switches, commonly referred to as Tier 1 (T1) and Tier 2 (T2) switches, forming a core interconnection network. Packets are routed among various intermediary nodes 106 of VNet 104 and/or physical network 102, which includes a node 106a, a node 106b, a node 106c, a node 106d, and a mirroring node 130. Some examples may use a larger or smaller number of intermediary nodes. In some examples, VNet 104 comprises a software-defined network (SDN). In some examples, mirroring node 130 comprises a virtual traffic access point (VTAP). Some examples may use multiple ones of mirroring node 130 and/or mirroring logic 132 (within a single mirroring node 130) to scale up to a higher traffic capacity (i.e., reducing the effect of any bandwidth limitations of a single instance of mirroring logic 132).

VNet 104 provides connectivity between (VMs) within its boundaries. VNet 104 is a logical overlay network implemented over the infrastructure of physical network 102, using network encapsulation technologies, such as virtual extensible local area network (VXLAN). The address space of an overlay VNet is inherently non-routable. However, by encapsulating overlay packets within the underling physical network's routable address space and embedding VNet identifiers within the encapsulated packets, it becomes possible to route packets between end hosts. The hosts have network drivers that are responsible for evaluating VNet Access Control Lists (VNet ACLs) and routing policies. Additionally, the network drivers handle the encapsulation of overlay packets at the sender (origin) VM host and decapsulation at the receiver (destination) VM host.

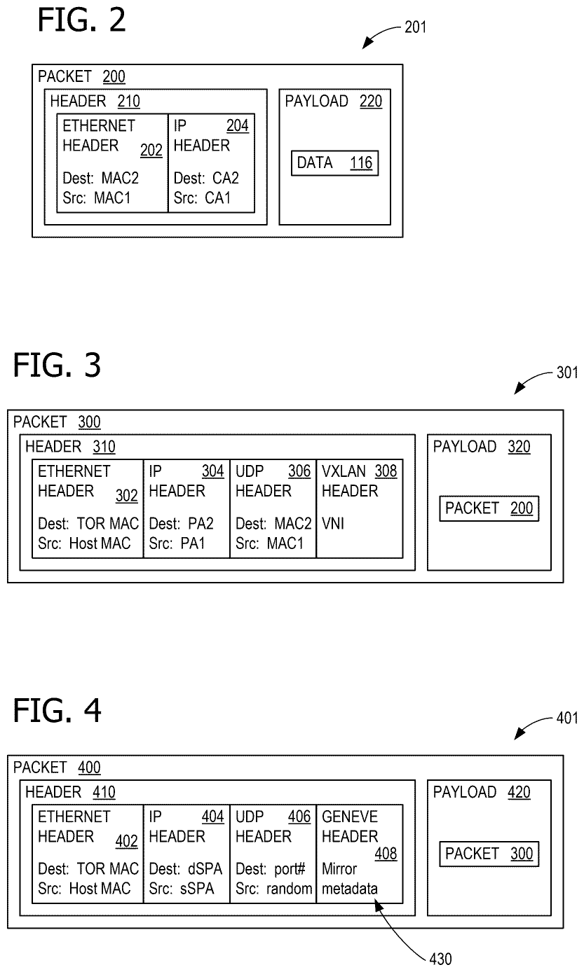

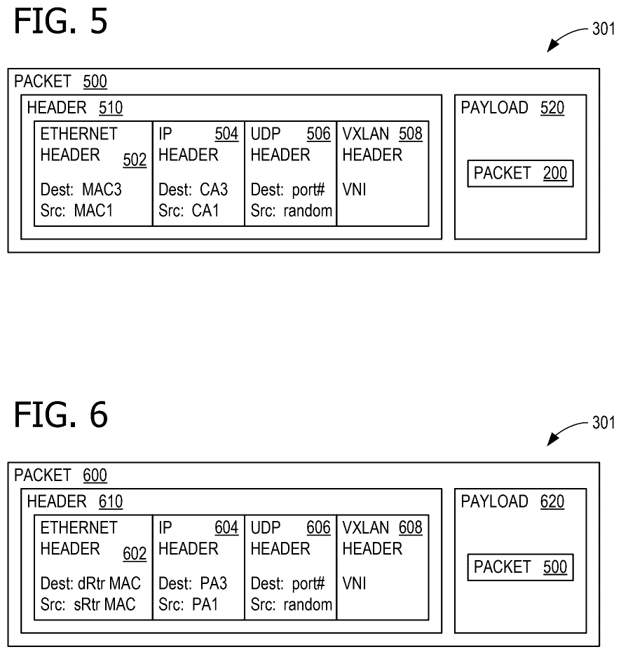

In the scenario depicted in FIG. 1, an origin VM 112 in an origin host 110 sends a packet 200, containing data 116, to destination VM 122 in a destination host 120. Packet 200 is encapsulated within a packet 300, which in turn, is encapsulated within a packet 400. Packet 200 is mirrored, with a copy sent to a mirror VM in a mirror host 140, encapsulated within a packet 500, which in turn, is encapsulated within a packet 600. Packet 200 is illustrated in further detail in FIG. 2, packet 300 is illustrated in further detail in FIG. 3, packet 400 is illustrated in further detail in FIG. 4, packet 500 is illustrated in further detail in FIG. 5, and packet 600 is illustrated in further detail in FIG. 6. The encapsulation and mirroring is described in further detail below.

Origin host 110 has a network driver 114, destination host 120 has a network driver 124, and mirror host 140 has a network driver 144. The routable addresses of host machine (e.g., origin host 110, destination host 120, and mirror host 140) use physical addresses (PAs) for routing, whereas VMs (e.g., origin VM 112, destination VM 122, and mirror VM 142) use customer addresses (CAs). As shown, origin host 110 has PA1, origin VM 112 has CA1, destination host 120 has PA2, destination VM 122 has CA2, mirror host 140 has PA3, and mirror VM 142 has CA3. Network driver 114 has a media access control (MAC) address shown as MAC1, network driver 124 has a MAC address shown as MAC2, and network driver 144 has a MAC address shown as MAC3.

Origin VM 112 generates packet 200 to transmit data 116 to destination VM 122. Encapsulation logic 118, which may have its functionality distributed among origin VM 112, network driver 114, and other logic within origin host 110, encapsulates packet 200 within packet 300, then encapsulates packet 300 within packet 400, and then transmits packet 400 toward destination VM 122 across VNet 104. As described in relation to FIG. 4, encapsulation logic 118 inserts metadata into packet 400 for use by a mirroring logic 132 of mirroring node 130, when packet 400 arrives at mirroring node 130. This metadata is shown as mirror metadata 430 in FIG. 4.

When packet 400 arrives at mirroring node 130, mirroring logic 132 extracts packet 300, packet 200, and mirror metadata 430 from packet 400, and forwards packet 300 to destination host 120. When packet 300 arrives at destination host 120 network driver 124 extracts packet 200 from packet 300 and sends packet 200 to destination VM 122.

Mirroring logic 132 also uses mirror metadata 430 to encapsulate packet 200 within packet 500, then encapsulate packet 500 within packet 600, and then transmit packet 600 toward mirror VM 142. Mirroring logic 132 does not need to have any addresses programmed into it, because the addresses of mirror host 140 and mirror VM 142 are within mirror metadata 430. Mirroring logic 132 needs only to have the functionality to (1) extract packet 300 from packet 400, (2) forward packet 300 (to the destination already shown within packet 300), (3) extract packet 200 from packet 300, (4) extract mirror metadata 430 from a predefined field of packet 400, and (5) double-encapsulate packet 200 using addresses extracted from mirror metadata 430. This functionality is rather simple, and so may be easily implemented in an ASIC. Thus, some examples of mirroring logic 132 use ASICs to perform the extraction and encapsulation descried herein for mirroring node 130. Some versions of mirroring node 130 may use multiple ASICs (i.e., multiple instances of mirroring logic 132) and/or some examples of architecture 100 may use multiple ones of mirroring node 130, in order to scale out capacity.

When packet 400 arrives at mirror host 140 packet 200 is extracted. That is, packet 500 is extracted from packet 600, and packet 200 is extracted from packet 500. Packet 200 is then analyzed in any manner that may be common for mirrored packets, including for security issues. As illustrated, mirror VM 142 forwards packet 200 to a security monitoring function 150, which identifies a security threat 152 within packet 200. In some examples, security monitoring function 150 is within mirror VM 142. Security monitoring function 150 is just one example of a function that may be performed for mirrored packets. Others may also be used, such as monitoring network compliance.

FIG. 2 illustrates further detail for packet 200. Packet 200 is in a format 201 that has a header 210 and a payload 220. Format 201 is a standard IP packet format. Header 210 has an Ethernet header 202 and an internet protocol (IP) header 204, but not a user datagram protocol (UDP) header, a VXLAN header, or a generic network virtualization encapsulation (Geneve) header. Header 210 identifies origin VM 112 as its source (using MAC1 and CA1) and destination VM 122 as its destination (using MAC2 and CA2). Payload 220 holds data 116.

FIG. 3 illustrates further detail for packet 300. Packet 300 is in a format 301 that has a header 310 and a payload 320. Payload 320 holds packet 200. Format 301 is a format for use in a VNet, and may be a VXLAN format. Header 310 has an Ethernet header 302, an IP header 304, a UDP header 306, and a VXLAN header 308. Header 310 identifies origin host 110 as its source (using MAC1 and PA1) and destination host 120 as its destination (using MAC2 and PA2). VXLAN header 308 holds VXLAN Network Identifier (VNI) information. Format 301 enables transmission of packet 300 across the underlying routing and switching components of physical network 102, so that packet 300 (carrying packet 200) may be delivered to destination host 120.

FIG. 4 illustrates further detail for packet 400. Packet 400 is in a format 401 that has a header 410 and a payload 420. Payload 420 holds packet 300. Format 401 is a network encapsulation protocol packet format, and may be the Geneve format. Header 410 has an Ethernet header 402, an IP header 404, a UDP header 406, and a Geneve header 408. Header 410 identifies origin host 110 as its source and mirroring node 130 as its destination. Geneve header 408 uses a defined format that includes a variable length data field, into which mirror metadata 430 may be placed. Mirror metadata 430 identifies mirror host 140 and mirror VM 142 as the destination for the encapsulation of mirrored packets (i.e., identifies MAC3, PA3, and CA3), and mirroring node 130 as the source of the encapsulation of mirrored packets.

This permits the stateless operation, because mirroring logic 132 does not need to be programmed with this mirroring information. Mirroring logic 132 instead just needs to be encoded to extract this information from mirror metadata 430 (which it extracts from header 410), and use it to construct packet 500 and packet 600. Thus, if mirroring information (e.g., mirror host 140 or mirror VM 142) changes, no changes are needed in mirroring node 130 or mirroring logic 132. The change is handled by updating the insertion of mirror metadata 430 at origin host 110. This is a simple change, far less burdensome than updating (or reprogramming) mirroring node 130.

FIG. 5 illustrates further detail for packet 500. Packet 500 is in format 301, with a header 510 and a payload 520. Payload 520 holds packet 200. Header 510 has an Ethernet header 502, an IP header 504, a UDP header 506, and a VXLAN header 508. Header 510 identifies origin VM 112 as its source (using MAC1 and CA1) and mirror VM 142 as its destination (using MAC3 and CA3). VXLAN header 508 holds VNI information.

FIG. 6 illustrates further detail for packet 600. Packet 600 is in format 301, with a header 610 and a payload 620. Payload 620 holds packet 500. Header 610 has an Ethernet header 602, an IP header 604, a UDP header 606, and a VXLAN header 608. Header 610 identifies origin host 110 as its source (using PA1) and mirror host 140 as its destination (using PA3). VXLAN header 508 holds VNI information. Format 301 enables transmission of packet 600 across the underlying routing and switching components of physical network 102, so that packet 600 (carrying packet 200) may be delivered to mirror host 140.

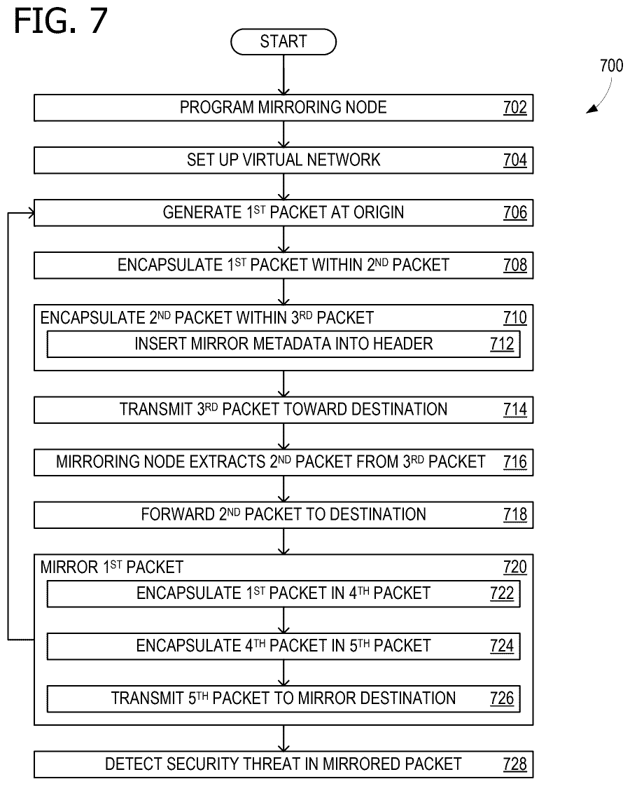

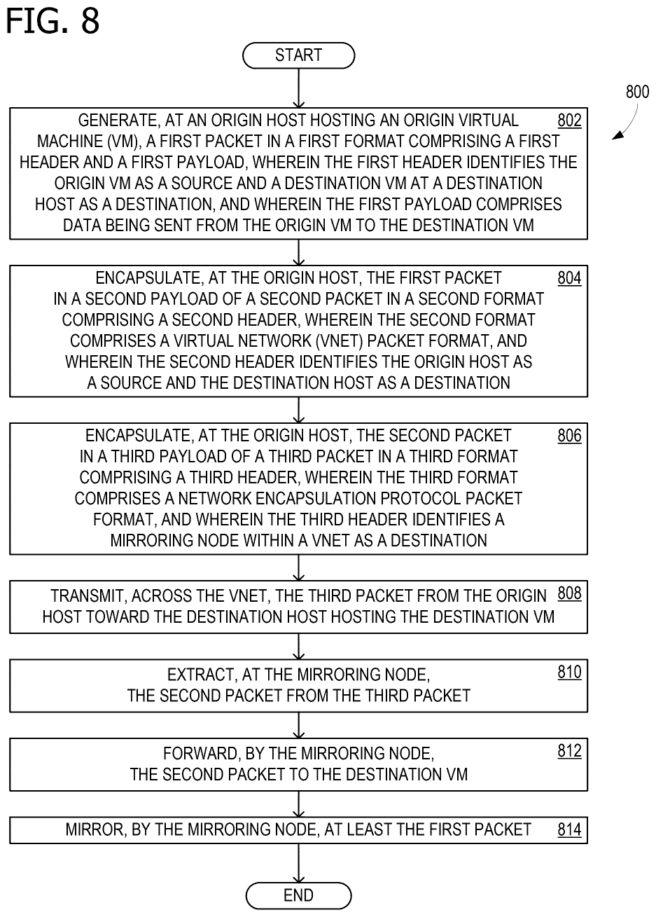

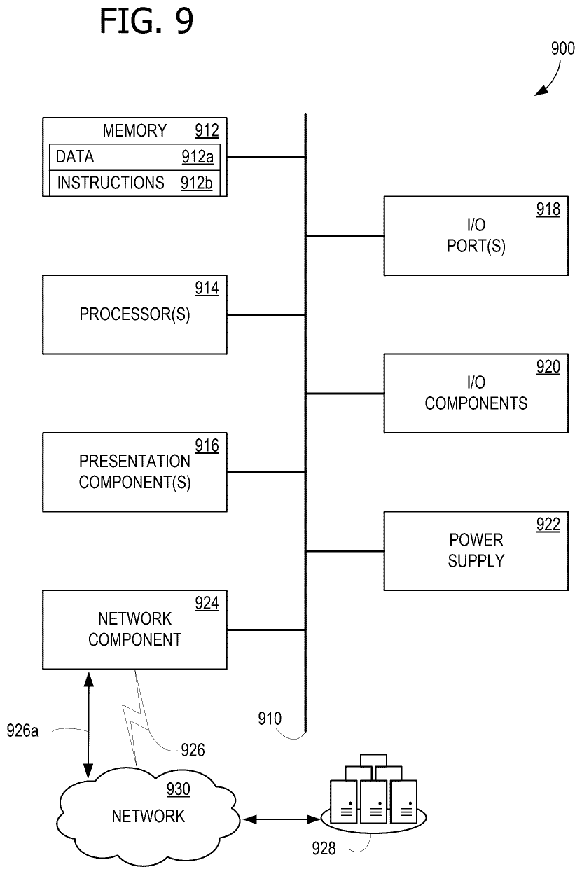

FIG. 7 shows a flowchart 700 illustrating exemplary operations that may be performed by architecture 100. In some examples, operations described for flowchart 700 are performed by computing device 900 of FIG. 9. Flowchart 700 commences with program mirroring node 130, specifically mirroring logic 132, to extract mirror metadata 430 and to mirror packets in accordance with the information within mirror metadata 430, in operation 702. This enables the stateless mirroring. VNet 104 is set up as an overlay of physical network 102 in operation 704.

In operation 706, packet 200 is generated, by VM 112 at origin host 110, to send data 116 to destination VM 122. Operation 708 encapsulates packet 200 in payload 320 of packet 300 at origin host 110. Operation 710 encapsulates packet 300 in payload 420 of packet 400 at origin host 110. Operation 710 uses operation 712, which inserts mirror metadata 430 into header 410. Mirror metadata 430 identifies mirror VM 142 as a destination for mirrored packets and mirroring node 130 as a source for mirrored packets.

Packet 400 is transmitted, from origin host 110 toward destination host 120, in operation 714. In operation 716, mirroring node 130 extracts packet 300 from packet 400, and mirroring node 130 forwards packet 200 (within packet 300) to destination VM 122 (via destination host 120), in operation 718.

Mirroring node 130 mirrors packet 200 in operation 720, using operations 722-726. Operation 722 encapsulates packet 200 in payload 520 of packet 500. Operation 724 encapsulates packet 500 in payload 620 of packet 600. Operation 726 transmits packet 600 from mirroring node 130 to mirror VM 142. Operation 728 leverages the mirroring of operation 720 for a practical benefit by detecting security threat 152 using packet 200. In some examples, mirror VM 142 comprises security monitoring function 150, whereas in some other examples, mirror VM 142 forwards packet 200 to security monitoring function 150 as part of operation 728. Flowchart 700 returns to operation 706 for the next packet that origin VM 112 sends to destination VM 122.

FIG. 8 shows a flowchart 800 illustrating exemplary operations that may be performed by architecture 100. In some examples, operations described for flowchart 800 are performed by computing device 900 of FIG. 9. Flowchart 800 commences with operation 802, which includes generating, at an origin host hosting an origin VM, a first packet in a first format comprising a first header and a first payload, wherein the first header identifies the origin VM as a source and a destination VM at a destination host as a destination, and wherein the first payload comprises data being sent from the origin VM to the destination VM.

Operation 804 includes encapsulating, at the origin host, the first packet in a second payload of a second packet in a second format comprising a second header, wherein the second format comprises a VNet packet format, and wherein the second header identifies the origin host as a source and the destination host as a destination. Operation 806 includes encapsulating, at the origin host, the second packet in a third payload of a third packet in a third format comprising a third header, wherein the third format comprises a network encapsulation protocol packet format, and wherein the third header identifies a mirroring node within a VNet as a destination.

Operation 808 includes transmitting, across the VNet, the third packet from the origin host toward the destination host hosting the destination VM. Operation 810 includes extracting, at the mirroring node, the second packet from the third packet. Operation 812 includes forwarding, by the mirroring node, the second packet to the destination VM. Operation 814 includes mirroring, by the mirroring node, at least the first packet.

### Additional Examples

An example system comprises: a processor; and a computer-readable medium storing instructions that are operative upon execution by the processor to: generate, at an origin host hosting an origin VM, a first packet in a first format comprising a first header and a first payload, wherein the first header identifies the origin VM as a source and a destination VM at a destination host as a destination, and wherein the first payload comprises data being sent from the origin VM to the destination VM; encapsulate, at the origin host, the first packet in a second payload of a second packet in a second format comprising a second header, wherein the second format comprises a VNet packet format, and wherein the second header identifies the origin host as a source and the destination host as a destination; encapsulate, at the origin host, the second packet in a third payload of a third packet in a third format comprising a third header, wherein the third format comprises a network encapsulation protocol packet format, and wherein the third header identifies a mirroring node within a VNet as a destination; transmit, across the VNet, the third packet from the origin host toward the destination host hosting the destination VM; extract, at the mirroring node, the second packet from the third packet; forward, by the mirroring node, the second packet to the destination VM; and mirror, by the mirroring node, at least the first packet.

An example computer-implemented method comprises: generating, at an origin host hosting an origin VM, a first packet in a first format comprising a first header and a first payload, wherein the first header identifies the origin VM as a source and a destination VM at a destination host as a destination, and wherein the first payload comprises data being sent from the origin VM to the destination VM; encapsulating, at the origin host, the first packet in a second payload of a second packet in a second format comprising a second header, wherein the second format comprises a VNet packet format, and wherein the second header identifies the origin host as a source and the destination host as a destination; encapsulating, at the origin host, the second packet in a third payload of a third packet in a third format comprising a third header, wherein the third format comprises a network encapsulation protocol packet format, and wherein the third header identifies a mirroring node within the VNet as a destination; transmitting, across the VNet, the third packet from the origin host toward the destination host hosting the destination VM; extracting, at the mirroring node, the second packet from the third packet; forwarding, by the mirroring node, the second packet to the destination VM; and mirroring, by the mirroring node, at least the first packet.

One or more example computer storage devices have computer-executable instructions stored thereon, which, on execution by a computer, cause the computer to perform operations comprising: generating, at an origin host hosting an origin VM, a first packet in a first format comprising a first header and a first payload, wherein the first header identifies the origin VM as a source and a destination VM at a destination host as a destination, and wherein the first payload comprises data being sent from the origin VM to the destination VM; encapsulating, at the origin host, the first packet in a second payload of a second packet in a second format comprising a second header, wherein the second format comprises a VNet packet format, and wherein the second header identifies the origin host as a source and the destination host as a destination; encapsulating, at the origin host, the second packet in a third payload of a third packet in a third format comprising a third header, wherein the third format comprises a network encapsulation protocol packet format, and wherein the third header identifies a mirroring node within a VNet as a destination; transmitting, across the VNet, the third packet from the origin host toward the destination host hosting the destination VM; extracting, at the mirroring node, the second packet from the third packet; forwarding, by the mirroring node, the second packet to the destination VM; and mirroring, by the mirroring node, at least the first packet.

Alternatively, or in addition to the other examples described herein, examples include any combination of the following:
based on at least the mirroring, detecting a security threat using the first packet;
mirroring the first packet comprises encapsulating, by the mirroring node, the first packet in a fourth payload of a fourth packet in the second format comprising a fourth header;
the fourth header identifies the origin VM as a source and a mirror VM as a destination;
mirroring the first packet comprises encapsulating, by the mirroring node, the fourth packet in a fifth payload of a fifth packet in the second format comprising a fifth header;
the fifth header identifies the origin host as a source and the mirror host as a destination;
mirroring the first packet comprises transmitting the fifth packet from the mirroring node to the mirror VM;
the mirroring node comprises an ASIC;
the ASIC performs the extraction and encapsulation of the mirroring node;
first header comprises an IP header identifying the origin VM and the destination VM;
the first format does not include a UDP header or a VXLAN header;
the VNet packet format comprises a VXLAN packet format;
the VXLAN format comprises an IP header, a UDP header, and a VXLAN header;
the network encapsulation protocol packet format comprises a Geneve packet format;
the Geneve packet format comprises an IP header, a UDP header, and a Geneve header;
the first header comprises a first Ethernet header preceding the IP header of the first packet;
the second header comprises a second Ethernet header preceding the IP header of the second packet;
the third header comprises a third Ethernet header preceding the IP header of the third packet;
the fourth header comprises a fourth Ethernet header preceding the IP header of the fourth packet;
the fifth header comprises a fifth Ethernet header preceding the IP header of the fifth packet;
each Ethernet header uses MAC addresses;
the IP headers of the first packet and the fourth packet use CAs;
the IP headers of the second packet, the third packet, and the fifth packet use PAs;
the third header further comprises mirror metadata identifying the mirror VM as a destination for mirrored packets;
the third header further comprises mirror metadata identifying the mirroring node as a source for mirrored packets;
the VNet comprises an SDN;
mirroring node comprises a VTAP;
the mirroring comprises stateless mirroring; and
the mirror VM comprises a security monitoring function or the mirror VM forwards the first packet to the security monitoring function.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 9 is a block diagram of an example computing device 900 (e.g., a computer storage device) for implementing aspects disclosed herein, and is designated generally as computing device 900. In some examples, one or more computing devices 900 are provided for an on-premises computing solution. In some examples, one or more computing devices 900 are provided as a cloud computing solution. In some examples, a combination of on-premises and cloud computing solutions are used. Computing device 900 is but one example of a suitable computing environment and is not intended to suggest any limitation as to the scope of use or functionality of the examples disclosed herein, whether used singly or as part of a larger set.

Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 910 that directly or indirectly couples the following devices: computer storage memory 912 (i.e., a computer-readable medium), one or more processors 914, one or more presentation components 916, input/output (I/O) ports 918, I/O components 920, a power supply 922, and a network component 924. While computing device 900 is depicted as a seemingly single device, multiple computing devices 900 may work together and share the depicted device resources. For example, memory 912 may be distributed across multiple devices, and processor(s) 914 may be housed with different devices.

Bus 910 represents what may be one or more buses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 912 may take the form of the computer storage media referenced below and operatively provide storage of computer-readable instructions, data structures, program modules and other data for the computing device 900. In some examples, memory 912 stores one or more of an operating system, a universal application platform, or other program modules and program data. Memory 912 is thus able to store and access data 912a and instructions 912b that are executable by processor 914 and configured to carry out the various operations disclosed herein. Thus, computing device 900 comprises a computer storage device having computer-executable instructions 912b stored thereon.

In some examples, memory 912 includes computer storage media. Memory 912 may include any quantity of memory associated with or accessible by the computing device 900. Memory 912 may be internal to the computing device 900 (as shown in FIG. 9), external to the computing device 900 (not shown), or both (not shown). Additionally, or alternatively, the memory 912 may be distributed across multiple computing devices 900, for example, in a virtualized environment in which instruction processing is carried out on multiple computing devices 900. For the purposes of this disclosure, “computer storage media,” “computer storage memory,” “memory,” and “memory devices” are synonymous terms for the memory 912, and none of these terms include carrier waves or propagating signaling.

Processor(s) 914 may include any quantity of processing units that read data from various entities, such as memory 912 or I/O components 920. Specifically, processor(s) 914 are programmed to execute computer-executable instructions for implementing aspects of the disclosure. The instructions may be performed by the processor, by multiple processors within the computing device 900, or by a processor external to the client computing device 900. In some examples, the processor(s) 914 are programmed to execute instructions such as those illustrated in the flow charts discussed below and depicted in the accompanying drawings. Moreover, in some examples, the processor(s) 914 represents an implementation of analog techniques to perform the operations described herein. For example, the operations may be performed by an analog client computing device 900 and/or a digital client computing device 900. Presentation component(s) 916 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 918 allow computing device 900 to be logically coupled to other devices including I/O components 920, some of which may be built in. Example I/O components 920 include, for example but without limitation, a microphone, joystick, game pad, satellite dish, scanner, printer, wireless device, etc.

Computing device 900 may operate in a networked environment via the network component 924 using logical connections to one or more remote computers. In some examples, the network component 924 includes a network interface card and/or computer-executable instructions (e.g., a driver) for operating the network interface card. Communication between the computing device 900 and other devices may occur using any protocol or mechanism over any wired or wireless connection. In some examples, network component 924 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 924 communicates over wireless communication link 926 and/or a wired communication link 926a to a remote resource 928 (e.g., a cloud resource) across a computer network 930. Various different examples of communication links 926 and 926a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
generate, at an origin host hosting an origin virtual machine (VM), a first packet in a first format comprising a first header and a first payload, wherein the first header identifies the origin VM as a source and a destination VM at a destination host as a destination, and wherein the first payload comprises data being sent from the origin VM to the destination VM;
encapsulate, at the origin host, the first packet in a second payload of a second packet in a second format comprising a second header, wherein the second format comprises a virtual network (VNet) packet format, and wherein the second header identifies the origin host as a source and the destination host as a destination;
encapsulate, at the origin host, the second packet in a third payload of a third packet in a third format comprising a third header, wherein the third format comprises a network encapsulation protocol packet format, and wherein the third header identifies a mirroring node within a VNet as a destination;
transmit, across the VNet, the third packet from the origin host toward the destination host hosting the destination VM;
extract, at the mirroring node, the second packet from the third packet;
forward, by the mirroring node, the second packet to the destination VM; and
mirror, by the mirroring node, at least the first packet.

2. The system of claim 1, wherein the instructions are further operative to:
based on at least the mirroring, detect a security threat using the first packet or monitor VNet compliance.

3. The system of claim 1, wherein mirroring at least the first packet comprises:
encapsulating, by the mirroring node, the first packet in a fourth payload of a fourth packet comprising a fourth header, wherein the fourth header identifies the origin VM as a source and a mirror VM as a destination;
encapsulating, by the mirroring node, the fourth packet in a fifth payload of a fifth packet comprising a fifth header, wherein the fifth header identifies the origin host as a source and the mirror host as a destination; and
transmitting the fifth packet from the mirroring node to the mirror VM.

4. The system of claim 3, wherein the mirroring node comprises one or more application specific integrated circuits (ASICs), and wherein each ASIC performs the extraction and encapsulation of the mirroring node.

5. The system of claim 3,
wherein the first header comprises an internet protocol (IP) header identifying the origin VM and the destination VM;
wherein the first format does not include a user datagram protocol (UDP) header or a virtual extensible local area network (VXLAN) header;
wherein the VNet packet format comprises a VXLAN packet format;
wherein the VXLAN format comprises an IP header, a UDP header, and a VXLAN header;
wherein the network encapsulation protocol packet format comprises a generic network virtualization encapsulation (Geneve) packet format; and
wherein the Geneve packet format comprises an IP header, a UDP header, and a Geneve header.

6. The system of claim 1, wherein the mirroring comprises stateless mirroring.

7. A computer-implemented method comprising:
generating, at an origin host hosting an origin virtual machine (VM), a first packet in a first format comprising a first header and a first payload, wherein the first header identifies the origin VM as a source and a destination VM at a destination host as a destination, and wherein the first payload comprises data being sent from the origin VM to the destination VM;
encapsulating, at the origin host, the first packet in a second payload of a second packet in a second format comprising a second header, wherein the second format comprises a virtual network (VNet) packet format, and wherein the second header identifies the origin host as a source and the destination host as a destination;
encapsulating, at the origin host, the second packet in a third payload of a third packet in a third format comprising a third header, wherein the third format comprises a network encapsulation protocol packet format, and wherein the third header identifies a mirroring node within a VNet as a destination;
transmitting, across the VNet, the third packet from the origin host toward the destination host hosting the destination VM;
extracting, at the mirroring node, the second packet from the third packet;
forwarding, by the mirroring node, the second packet to the destination VM; and
mirroring, by the mirroring node, at least the first packet.

8. The computerized method of claim 7, further comprising:
based on at least the mirroring, detecting a security threat using the first packet.

9. The computerized method of claim 7, wherein mirroring at least the first packet comprises:
encapsulating, by the mirroring node, the first packet in a fourth payload of a fourth packet comprising a fourth header, wherein the fourth header identifies the origin VM as a source and a mirror VM as a destination;
encapsulating, by the mirroring node, the fourth packet in a fifth payload of a fifth packet comprising a fifth header, wherein the fifth header identifies the origin host as a source and the mirror host as a destination; and
transmitting the fifth packet from the mirroring node to the mirror VM.

10. The computerized method of claim 9, wherein the mirroring node comprises an application specific integrated circuit (ASIC), and wherein the ASIC performs the extraction and encapsulation of the mirroring node.

11. The computerized method of claim 9,
wherein the first header comprises an internet protocol (IP) header identifying the origin VM and the destination VM;
wherein the first format does not include a user datagram protocol (UDP) header or a virtual extensible local area network (VXLAN) header;
wherein the VNet packet format comprises a VXLAN packet format;
wherein the VXLAN format comprises an IP header, a UDP header, and a VXLAN header;
wherein the network encapsulation protocol packet format comprises a generic network virtualization encapsulation (Geneve) packet format; and
wherein the Geneve packet format comprises an IP header, a UDP header, and a Geneve header.

12. The computerized method of claim 11,
wherein the first header comprises a first Ethernet header preceding the IP header of the first packet;
wherein the second header comprises a second Ethernet header preceding the IP header of the second packet;
wherein the third header comprises a third Ethernet header preceding the IP header of the third packet;
wherein the fourth header comprises a fourth Ethernet header preceding the IP header of the fourth packet; and
wherein the fifth header comprises a fifth Ethernet header preceding the IP header of the fifth packet.

13. The computerized method of claim 12,
wherein each Ethernet header uses media access control (MAC) addresses;
wherein the IP headers of the first packet and the fourth packet use customer addresses (CAs); and
wherein the IP headers of the second packet, the third packet, and the fifth packet use physical addresses (PAs).

14. The computerized method of claim 9, wherein the third header further comprises mirror metadata identifying the mirror VM as a destination for mirrored packets.

15. The computerized method of claim 7, wherein the mirroring comprises stateless mirroring.

16. A computer storage device having computer-executable instructions stored thereon, which, on execution by a computer, cause the computer to perform operations comprising:
generating, at an origin host hosting an origin virtual machine (VM), a first packet in a first format comprising a first header and a first payload, wherein the first header identifies the origin VM as a source and a destination VM at a destination host as a destination, and wherein the first payload comprises data being sent from the origin VM to the destination VM;
encapsulating, at the origin host, the first packet in a second payload of a second packet in a second format comprising a second header, wherein the second format comprises a virtual network (VNet) packet format, and wherein the second header identifies the origin host as a source and the destination host as a destination;
encapsulating, at the origin host, the second packet in a third payload of a third packet in a third format comprising a third header, wherein the third format comprises a network encapsulation protocol packet format, and wherein the third header identifies a mirroring node within a VNet as a destination;
transmitting, across the VNet, the third packet from the origin host toward the destination host hosting the destination VM;
extracting, at the mirroring node, the second packet from the third packet;
forwarding, by the mirroring node, the second packet to the destination VM; and
mirroring, by the mirroring node, at least the first packet.

17. The computer storage device of claim 16, wherein the operations further comprise:
based on at least the mirroring, detecting a security threat using the first packet.

18. The computer storage device of claim 16, wherein mirroring at least the first packet comprises:
encapsulating, by the mirroring node, the first packet in a fourth payload of a fourth packet in the second format comprising a fourth header, wherein the fourth header identifies the origin VM as a source and a mirror VM as a destination;
encapsulating, by the mirroring node, the fourth packet in a fifth payload of a fifth packet in the second format comprising a fifth header, wherein the fifth header identifies the origin host as a source and the mirror host as a destination; and
transmitting the fifth packet from the mirroring node to the mirror VM.

19. The computer storage device of claim 18, wherein the mirroring node comprises an application specific integrated circuit (ASIC), and wherein the ASIC performs the extraction and encapsulation of the mirroring node.

20. The computer storage device of claim 18,
wherein the first header comprises an internet protocol (IP) header identifying the origin VM and the destination VM;
wherein the first format does not include a user datagram protocol (UDP) header or a virtual extensible local area network (VXLAN) header;
wherein the VNet packet format comprises a VXLAN packet format;
wherein the VXLAN format comprises an IP header, a UDP header, and a VXLAN header;
wherein the network encapsulation protocol packet format comprises a generic network virtualization encapsulation (Geneve) packet format; and
wherein the Geneve packet format comprises an IP header, a UDP header, and a Geneve header.
